(19) United States
(12) Patent Application Publication
(10) Pub. No.: US 2021/0157279 A1
(43) Pub. Date: May 27, 2021

(54) Time Correction Method, And Time Correction System

(71) Applicant: Seiko Epson Corporation, Tokyo (JP)

(72) Inventor: Hidenori NAKAMURA, Shimosuwa (JP)

(21) Appl. No.: 16/953,437

(22) Filed: Nov. 20, 2020

(30) Foreign Application Priority Data
Nov. 22, 2019 (JP) 2019-211166

(51) Int. Cl. G04R 20/28; G04R 40/06; H04W 4/80; H04W 8/00

(52) U.S. Cl. CPC G04R 20/28; H04W 8/005; H04W 4/80; G04R 40/06

(57) ABSTRACT

A time correction method is a method performed using wireless communication between an electronic apparatus that includes a first wireless communication unit, and an electronic timepiece that includes a second wireless communication unit. The time correction method includes the electronic timepiece starting wireless reception, the electronic apparatus generating an advertising signal including time data held by the electronic apparatus and starting transmission of the advertising signal, and the electronic timepiece receiving the advertising signal. The electronic timepiece updates time data held by the electronic timepiece based on the time data included in the received advertising signal.

The present application is based on, and claims priority from JP Application Serial Number 2019-211166, filed Nov. 22, 2019, the disclosure of which is hereby incorporated by reference herein in its entirety.

### BACKGROUND

### 1. Technical Field

The present disclosure relates to a time correction method, and a time correction system.

### 2. Related Art

In recent years, transmission and reception of data by wireless communication between a plurality of electronic apparatuses on which a short-range wireless module is mounted has become common. For example, in JP-A-2017-60151, in communication between a smartphone and an electronic timepiece, wireless communication is performed after establishing a pairing connection using the BLE standard. Note that BLE is an abbreviation of Bluetooth (registered trademark) Low Energy.

Further, in an electronic timepiece, such as a smart watch or a multi-functional watch, that is equipped with the short-range wireless module, there is a desire to perform time correction using short-range wireless communication.

However, in the communication method disclosed in JP-A-2017-60151, the pairing is required, and there has therefore been issues in that it takes time and effort to make the connection, and power is also consumed. Specifically, in order to establish the pairing, after performing a predetermined operation on a central device and a peripheral device, a plurality of steps are necessary and take time, such as advertising, scanning, authentication of profile data, and the like. Furthermore, even after the pairing is established, it is necessary to maintain a constantly connected state, and therefore power consumption is high. Further, even if the connection is disconnected, it is necessary to regularly scan a connection counterpart, and power is consumed. In other words, an object of the present disclosure is to provide a time correction method and a time correction system in which power consumption is small and time correction can be easily performed.

### SUMMARY

A time correction method according to the present application is a time correction method performed using wireless communication between an electronic apparatus that includes a first wireless communication unit, and an electronic timepiece that includes a second wireless communication unit, the method including starting wireless reception by the electronic timepiece, generating, by the electronic apparatus, an advertising signal including time data held by the electronic apparatus, and starting transmission, by the electronic apparatus, of the advertising signal, and receiving, by the electronic timepiece, the advertising signal. The electronic timepiece updates time data held by the electronic timepiece based on the time data included in the received advertising signal.

The first wireless communication unit and the second wireless communication unit may be wireless communication modules conforming to the BLE standard, and the wireless communication may be broadcast communication using the BLE standard.

The time data may include a date and a time.

When the electronic apparatus starts transmission of the advertising signal, the electronic apparatus may repeatedly transmit the advertising signal at a predetermined interval until a predetermined time period elapses, and the electronic timepiece may end the wireless reception when reception of the advertising signal is successful.

The predetermined interval may be less than one second.

The starting the wireless reception by the electronic timepiece may be performed when a time in the electronic timepiece is a predetermined regular correction time, and the start of the transmission of the advertising signal by the electronic apparatus may be performed when a time in the electronic apparatus is the regular correction time.

The electronic timepiece may be provided in a plurality thereof.

A time correction system according to the present application is a time correction including an electronic apparatus that includes a first wireless communication unit and an electronic timepiece that includes a second wireless communication unit. The time correction system includes standing by in a reception mode, by the electronic timepiece, when the second wireless communication unit receives an operation to enter the reception mode, and generating, by the electronic apparatus, an advertising signal including time data of the electronic apparatus, when the first wireless communication unit receives an operation to enter a transmission mode, and then starting advertising, by the electronic apparatus. When the electronic timepiece receives the advertising signal, the electronic timepiece updates time data of the electronic timepiece based on the time data included in the received advertising signal.

### BRIEF DESCRIPTION OF THE DRAWINGS

FIG. 1 is a schematic configuration diagram of a time correction system according to a first embodiment.

FIG. 2 is a block diagram illustrating a schematic configuration of a smartphone.

FIG. 3 is a block diagram illustrating a schematic configuration of a watch.

FIG. 4 is a flowchart diagram illustrating a flow of processing in a time correction method.

FIG. 5 is a configuration diagram of an advertising signal.

FIG. 6 is a schematic configuration diagram of a time correction system according to a second embodiment.

FIG. 7 is a schematic configuration diagram of a time correction system according to a third embodiment.

### DESCRIPTION OF EXEMPLARY EMBODIMENTS

### First Embodiment

### Overview of Time Correction System

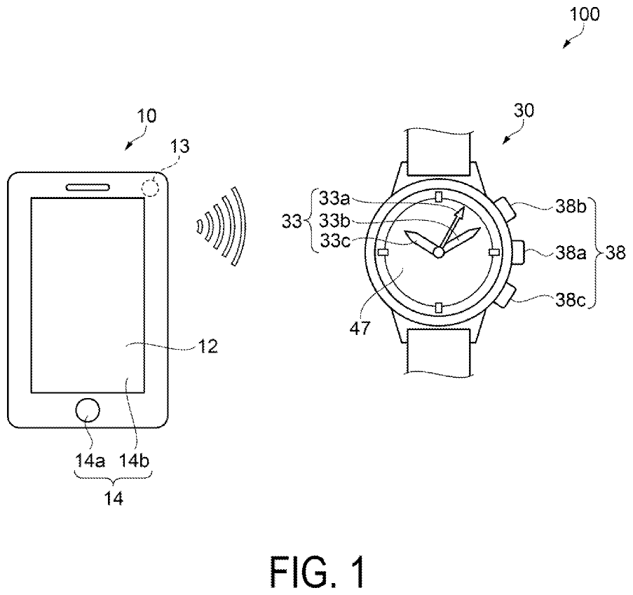

FIG. 1 is a schematic configuration diagram of a time correction system according to a present embodiment.

As illustrated in FIG. 1, a time correction system 100 is configured by a smartphone 10 as an electronic apparatus and a watch 30 as an electronic timepiece.

The smartphone 10 is a smartphone and includes a display unit 12, an operation button 14a, an imaging unit 13, and the like. Note that the display unit 12 is provided with a touch panel 14b, and the touch panel 14b also functions as an operation unit. The imaging unit 13 is provided on a rear surface when the display unit 12 is a front surface.

The watch 30 is a three-hand analog watch that includes a seconds hand 33a, a minute hand 33b, and an hour hand 33c. Note that the present disclosure is not limited to the analog watch, and may be applied to a digital watch or a hybrid watch.

As will be described in detail below, both the smartphone 10 and the watch 30 are provided with a communication unit conforming to the BLE standard. BLE is an abbreviation of Bluetooth (registered trademark) Low Energy.

Here, the smartphone 10 and the watch 30 perform time correction using a broadcast communication function of the BLE standard. Specifically, because the smartphone 10 takes on the function of broadcaster on a transmission side and the watch 30 takes on the function of observer on a receiver side, the time correction of the watch 30 can be performed easily without performing the pairing. A detailed description will be given below.

Configuration of Smartphone and Watch

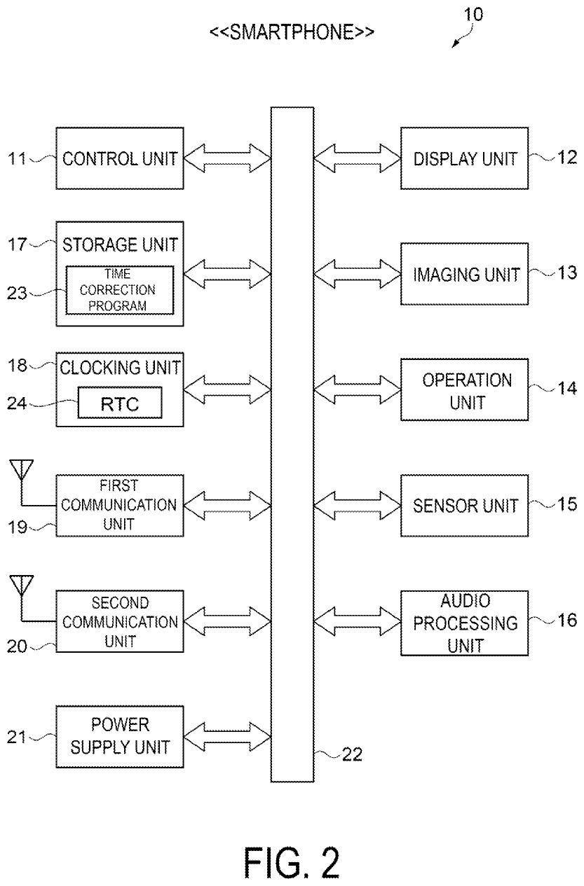

FIG. 2 is a block diagram illustrating a schematic configuration of the smartphone 10.

The smartphone 10 is configured by a control unit 11, the display unit 12, the imaging unit 13, the operation unit 14, a sensor unit 15, a voice processing unit 16, a storage unit 17, a clocking unit 18, a first communication unit 19, a second communication unit 20, a power supply unit 21, and the like. The control unit 11 is coupled to each of the above-described components via a data bus 22.

The control unit 11 is configured to include one or a plurality of processors. The control unit 11 controls overall operations of the smartphone 10 by operating in accordance with an operating system (OS) and application programs stored in the storage unit 17.

The display unit 12 is configured to include a display device, such as a liquid crystal display, an organic electroluminescence (EL) display, or the like, and displays images based on image data. Note that the display unit 12 includes the touch panel.

The imaging unit 13 is a camera provided with an imaging element, such as a charge coupled device (CCD) sensor, a complementary metal oxide semiconductor (CMOS) sensor, or the like.

The operation unit 14 is configured by an operation input unit, such as the operation button 14a, and the touch panel 14b configured integrally with the display unit 12, and an operation receiving unit that receives the operation input. For example, when a user operates the touch panel 14b, the operation unit 14 receives the input operation and outputs to the control unit 11, via the data bus 22, an operation signal corresponding to the operation content.

The sensor unit 15 is a motion sensor provided with a three-axis acceleration sensor and a three-axis gyro (angular velocity) sensor. The sensor unit 15 outputs a detection signal to the control unit 11 via the data bus 22 in accordance with a sampling frequency that is specified in advance. Note that the sensor unit 15 may be provided with other sensors.

The audio processing unit 16 is configured by a microphone, a speaker, and the like. The audio processing unit 16 converts digital audio data, provided via the data bus 22, to analog audio data and outputs the analog audio data from the speaker, while also sampling analog audio signals input from the microphone, converting the input signals to digital data and outputting the digital data.

The storage unit 17 is configured by a random access memory (RAM) and a memory, such as a read only memory (ROM), or the like. The storage unit 17 stores the OS, the application programs, various data, and the like. The application programs also include a time correction program 23. Further, the various data also include time data.

The clocking unit 18 is configured to include an RTC 24, which is a real time clock incorporating a crystal oscillator. The clocking unit 18 also continues to count the time when the control unit 11 is switched off, and supplies the time data to the control unit 11 when the control unit 11 is activated.

The first communication unit 19 is a communication unit that transmits and receives data, via an antenna, to and from a closest base station (not illustrated), on the basis of a fourth generation mobile communication system conforming to the IMT-Advance standard. Note that the communication unit 19 may be a communication unit conforming to a fifth generation mobile communication system.

The second communication unit 20 is a wireless communication module conforming to the BLE standard, and corresponds to a first wireless communication unit. Specifically, a wireless communication module is adopted in which a wireless communication integrated circuit (IC), an antenna, and a peripheral circuit are mounted on a single substrate. When the time correction program 23 of the storage unit 17 is executed, the second communication unit 20 performs communication processing, such as wireless transmission, in accordance with a procedure prescribed by the program. Note that the second communication unit 20 may be provided with a communication module for a wireless local area network (LAN).

The power supply unit 21 is configured by a battery such as a lithium ion battery, and a power supply circuit including a regulator and the like, and supplies power to drive each of the components of the smartphone 10.

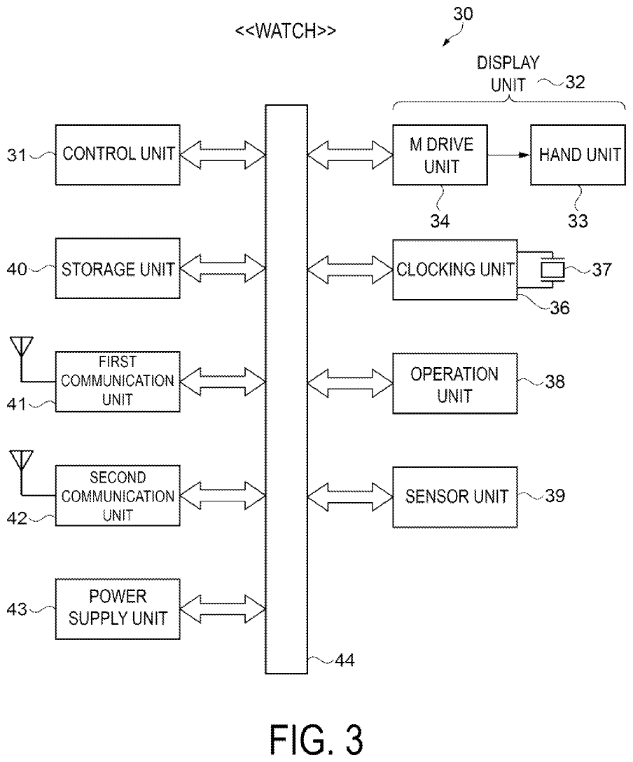

FIG. 3 is a block diagram illustrating a schematic configuration of the watch.

The watch 30 is configured by a control unit 31, a display unit 32, a clocking unit 36, an operation unit 38, a sensor unit 39, a storage unit 40, a first communication unit 41, a second communication unit 42, a power supply unit 43, and the like.

The control unit 31 is configured by a central processing unit (CPU), and controls, via a data bus 44, operations of each component of the watch 30, in accordance with a control program stored in the storage unit 40.

The display unit 32 is configured by a hand unit 33, an M drive unit 34, a dial 47 (FIG. 1), and the like. The hand unit 33 includes the seconds hand 33a, the minute hand 33b, and the hour hand 33c. The M drive unit 34 is provided with a motor for driving the seconds hand 33a, the minute hand 33b, and the hour hand 33c, and with a drive circuit of the motor. Note that a solar panel may be incorporated into the dial 47.

The clocking unit 36 is configured by a crystal oscillator 37, an oscillating circuit, and the like. The control unit 31 supplies, to the M drive unit 34, a signal obtained by dividing a reference signal from the clocking unit 36.

The operation unit 38 is provided with an operation button 38a, an operation button 38b, and an operation button 38c in FIG. 1. The operation button 38a is a crown, and by pulling and turning the crown, for example, it is possible to manually set the time of the seconds hand 33a, the minute hand 33b, and the hour hand 33c. Specific functions are assigned to the operation button 38b and the operation button 38c. The operation button 38b is assigned a function of switching to a time reception mode, and the function is activated by long pressing the operation button 38b for a predetermined amount of time, such as two seconds or longer, for example. Note that the switching operation may also be assigned to the operation button 38c or the crown, or the switching operation may be activated in accordance with an operation rather than the long pressing of the button.

The sensor unit 39 is a motion sensor including a three-axis acceleration sensor and a three-axis gyro (angular velocity) sensor. Note that the sensor unit 39 may include other sensors.

The storage unit 40 is configured by a random access memory (RAM) and a memory, such as a read only memory (ROM), or the like. The storage unit 40 stores an OS, application programs, various data, and the like. The application programs also include a time correction program. Further, the various data also include time data.

The first communication unit 41 is a standard radio wave receiving unit, and is configured by an antenna, a receiving circuit, an A/D converter circuit, and the like. After the standard radio waves are received by the antenna and the received analog signal is amplified by the receiving circuit, the analog signal is converted to a digital signal by the A/D converter circuit, and the digital signal is transmitted to the control unit 31 via the data bus 44. In the control unit 31, a drive signal is supplied to the M drive unit 34 on the basis of time information included in the digital signal from the first communication unit 41.

The second communication unit 42 is a radio communication module conforming to the BLE standard, in a similar manner to the second communication unit 20 of the smartphone 10, and corresponds to a second wireless communication unit.

The power supply unit 43 is configured by a battery such as a lithium ion battery, and a power supply circuit including a regulator, and the like. The battery supplies power to drive each of the components of the watch 30. The power supply unit 43 may also be provided with a solar panel below the dial 47 illustrated in FIG. 1, and a configuration may be adopted in which power generated by the solar panel is used to charge the battery.

Time Correction Program and Time Correction Method

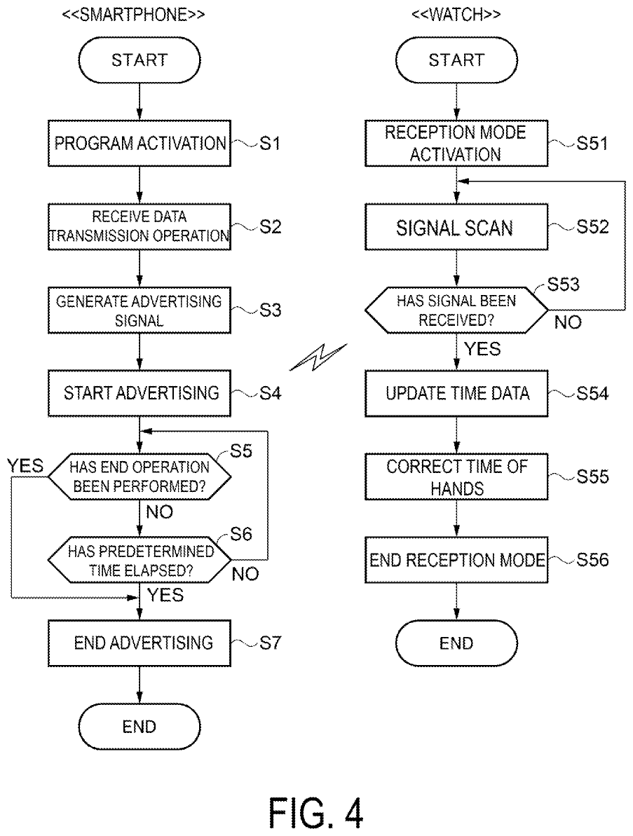

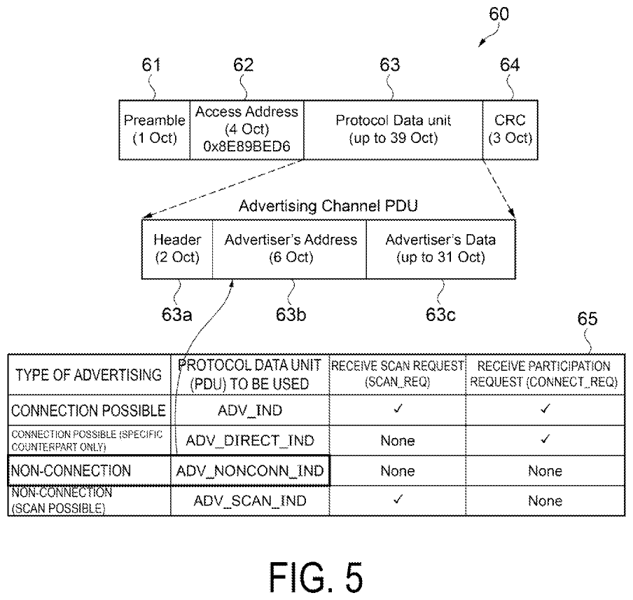

FIG. 4 is a flowchart diagram illustrating a flow of processing in a time correction method. FIG. 5 is a configuration diagram of an advertising signal.

Here, a time correction method in the time correction system 100 including the smartphone 10 and the watch 30 will be described mainly with reference to FIG. 4, and with reference to FIG. 1 to FIG. 5 as appropriate.

First, operations of the smartphone 10 will be described. Note that it is assumed that a “Bluetooth on” setting in the OS of the smartphone 10 is already complete in preparation. When Bluetooth is off, the second communication unit 20 (FIG. 2) does not function, so the following processing cannot be performed. Further, it is assumed that the time correction program 23 is already installed, and that an icon of the program is registered on the display unit 12 of the smartphone 10.

In the following description, the control unit 11 (FIG. 2) of the smartphone 10 mainly executes each of steps, and controls each of the components of the smartphone 10 in accordance with a processing flow of the time correction program 23 stored in the storage unit 17.

At step S1, a user selects and activates the time correction program 23 from the applications of the smartphone 10. Specifically, the user selects and touches the icon for the time correction program 23 displayed on the display unit 12 of the smartphone 10. In this way, the time correction program 23 is activated, and an operation screen with a plurality of operation buttons including a “start transmission” button and the like is displayed.

At step S2, a data transmission operation is received. Specifically, the operation unit 14 receives the user operation of selecting and touching the “start transmission” button, and outputs to the control unit 11, via the data bus 22, an operation signal corresponding to the operation content. In this way, the smartphone 10 is in a wireless transmission mode. Note that a “start reception” button is also provided on the operation screen of the application, and a wireless reception mode is switched to when this button is selected.

At step S3, an advertising signal 60 (illustrated in FIG. 5) used for time data transmission is generated. Specifically, the time data is read from the storage unit 17 and incorporated into the advertising signal 60. As illustrated in FIG. 5, the advertising signal 60 is an advertisement packet, which is one of the BLE communication packets, and is configured by a preamble 61, an access address 62, a protocol data unit 63, and a cyclic check code 64. Here, as illustrated by a table 65 in FIG. 5, the type of the protocol data unit 63 selects “non-connection” in the broadcast communication.

In this way, the protocol data unit 63 is configured by a header 63a, an advertising address 63b, and advertising data 63c. Then, the time data is included in the advertising data 63c. In a preferred example, the time data includes the year, month, day, hour, minute, second, and millisecond. Further, the time data may include a time zone, daylight saving time (DST), and the like. Note that the advertising data 63c may include a service universally unique identifier (UUID) in which a data region is a maximum of 31 octets.

At step S4, the smartphone 10 starts advertising as a broadcaster in the BLE standard broadcast communication. Specifically, the advertising signal 60 is wirelessly transmitted to the broadcast in accordance with a set interval. This step corresponds to starting an advertising signal. In the preferred example, the interval is 1/256 seconds, and is preferably from 20 milliseconds to 50 seconds or less. The interval is not limited thereto, and it is sufficient that the interval be less than one second.

At step S5, the presence or absence of an operation to end the advertising is determined. An end operation corresponds to the operation of an “end advertising” button on the operation screen of the time correction program, to a case in which an operation to end the program is performed, and the like. If the end operation has been performed, the processing proceeds to step S7. If the end operation has not been performed, the processing proceeds to step S6.

At step S6, it is determined whether a predetermined time period has elapsed. In the preferred example, the predetermined time period is three minutes. Note that the predetermined time period is not limited to this, and, given that when the predetermined time is longer, the power consumption is increased, the time period may be set, as appropriate, from 30 seconds to 5 minutes. If the predetermined time period has not been reached, the processing returns to step S5. If the predetermined time has been reached, the processing proceeds to step S7.

At step S7, the advertising is ended.

Next, operations of the watch 30 will be described.

In the following description, the control unit 31 (FIG. 3) of the watch 30 mainly executes each of steps, and controls each of the components of the watch 30 in accordance with the time correction program stored in the storage unit 40.

At step S51, the user activates a time reception mode. Specifically, when the user long presses the operation button 38b (FIG. 1) for two seconds or longer, a time display mode switches to the time reception mode. Note that, in order to reduce storage capacity, the time correction program of the watch 30 is a program dedicated to the wireless reception mode. In this way, the watch 30 is in the wireless reception mode.

At step S52, the watch 30 starts a scan as the observer in the BLE standard broadcast communication. Specifically, the watch 30 scans surrounding packet data. In other words, the watch 30 stands by in the time reception mode and continues the scan. This step corresponds to starting wireless reception. Note that, in order to clearly indicate that the time is being corrected, hand operation control that is different to normal hand operation may be performed, such as causing at least one of the three hands to rotate during the scan, to move in a reciprocating manner, or the like.

At step S53, it is determined whether the advertising signal 60 has been received. When the advertising signal 60 has been received, the processing proceeds to step S54. When the advertising signal 60 has not been received, the processing returns to step S52.

At step S54, the time data of the storage unit 40 is updated using the time data acquired from the received advertising signal 60.

At step S55, the date and the time of the display unit 32 are corrected on the basis of the updated time data. Note that a time period from the start of the scan to the end of the time correction is approximately one second.

At step S56, the time reception mode is ended and the watch 30 returns to the time display mode. In other words, since the advertising signal 60 has been successfully received and the time correction has ended, the watch 30 returns to the time display mode.

Advantages of First Embodiment

As described above, according to the present embodiment, the following advantages can be obtained.

According to the time correction method of the present embodiment, when the smartphone 10 is switched to the wireless transmission mode and the watch 30 is switched to the wireless reception mode, the smartphone 10 becomes the broadcaster in the BLE standard broadcast communication, and the watch 30 becomes the observer in the same broadcast communication. Then, the method includes the step in which the smartphone 10 generates the advertising signal 60 including its own time data and starts the advertising, and the step in which the watch 30 receives the advertising signal 60. The watch 30 updates its own time data on the basis of the time data of the received advertising signal 60.

In this way, by using the BLE standard broadcast communication, the watch 30 can acquire the time data without performing the pairing between the smartphone 10 and the watch 30. Thus, an operation relating to the pairing connection and a connection operation can be omitted, and thus the power consumption can be reduced and the time period up to the connection can be shortened. Furthermore, since it is not necessary to maintain a connected state in normal mutual communication, power saving is achieved.

Thus, the time correction method and the time correction system can be provided in which power consumption is low and the time correction can be easily performed.

Further, since the time data includes the date and the time, the date and the time of the watch 30 can be easily corrected.

When the smartphone 10 starts the advertising, the smartphone 10 repeatedly transmits the advertising signal 60 at the predetermined interval until the predetermined time period elapses. The predetermined interval is less than one second.

In this way, since the interval is less than one second, the time correction can be performed at every exact second during the time correction. When the interval is one second or more, it is necessary to pause the time correction until the next exact second, and unnecessary time is required.

Thus, the time correction method can be provided in which the time correction can be performed in a short period of time.

Furthermore, when the watch 30 successfully receives the advertising signal 60, the watch 30 ends the wireless reception mode after updating the time data.

In this way, the scanning need not be continued, and thus the power consumption can be reduced.

Further, when the time is corrected using the standard radio waves, a time of one minute or longer is necessary for the time correction, but according to the time correction method of the present embodiment, the time correction can be performed in approximately one second, and thus the time can be shortened significantly. Further, when the time correction is performed using radio waves from a global positioning system (GPS) satellite, radio waves can only be received outdoors, but, according to the time correction method of the present embodiment, the time correction can be easily performed indoors.

### Second Embodiment

### Time Correction Mode for Plurality of Watches

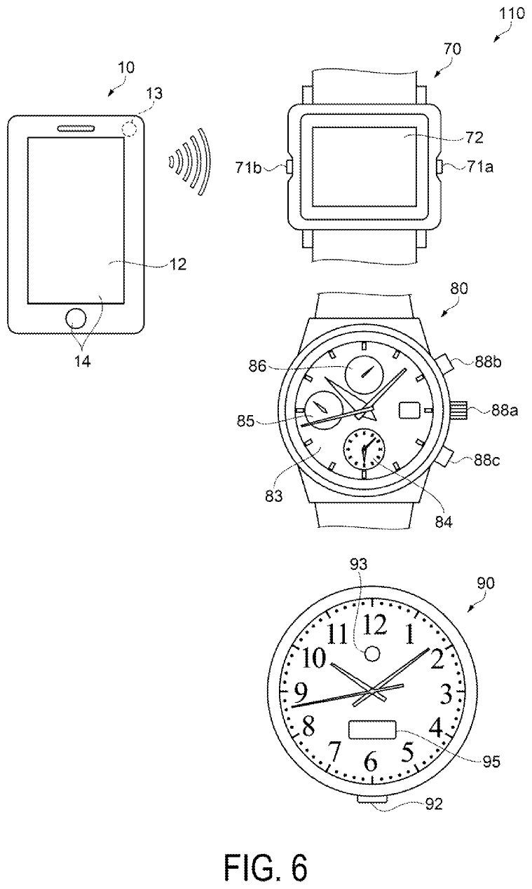

FIG. 6 is a schematic configuration diagram of a time correction system according to the present embodiment, and corresponds to FIG. 1.

Here, a time correction method in a time correction system 110 according to the present embodiment will be described. In the time correction system 100 of the first embodiment, the time correction method is described that is performed in a one-to-one manner between the smartphone 10 and the watch 30. However, the time correction method is not limited to this configuration, and the time correction using the BLE standard broadcast communication can also be performed between one device and a plurality of devices. Note that a description repeating that of the first embodiment will be omitted.

As illustrated in FIG. 6, the time correction system 110 is configured by the smartphone 10 as the electronic apparatus, and a smartwatch 70, a multi-functional watch 80, and a wall clock 90 as the electronic timepiece. The smartphone 10 is the same as the smartphone 10 of the first embodiment.

The smartwatch 70 is a smartwatch with a function that excludes the telephone function of the smartphone 10. Specifically, the smartwatch 70 has the same configuration as the smartphone 10 except that the smartwatch 70 is not provided with the first communication unit 19 illustrated in FIG. 2, and includes a wireless communication module conforming to the same BLE standard as the second communication unit 20. Further, a time correction program is stored in a storage unit (not illustrated). The smartwatch 70 is provided with a display unit 72 that is integrated with a touch panel, operation buttons 71a and 71b, and the like.

The multi-functional watch 80 is a multi-functional analog watch in which three small dials 84, 85, and 86, and each of pointers are provided in a main dial 83 provided with a seconds hand, a minute hand, and a hour hand. The multi-functional watch 80 is provided with a stopwatch function and an alarm function. The configuration of the multi-functional watch 80 is the same as that of the watch 30 of the first embodiment, except for the addition of a drive mechanism and circuit for the pointers of the small dials, and the multi-functional watch 80 is provided with a wireless communication module that conforms to the same BLE standard as the second communication unit 42 (FIG. 3). Further, a time correction program is stored in a storage unit (not illustrated). The multi-functional watch 80 is provided with operation buttons 88a, 88b, and 88c.

The wall clock 90 is an analog wall clock, and is provided with a second display unit 95 in a lower central portion of a dial thereof. The second display unit 95 is a liquid crystal panel, and the date/day of the week are displayed in the time display mode. An operation button 92 for switching to the time reception mode is provided below the dial. Further, an imaging unit 93 is provided in an upper central portion of the dial. The imaging unit 93 is a camera provided with an imaging device, such as a CCD sensor or a CMOS sensor.

The configuration of the wall clock 90 is the same as that of the watch 30 of the first embodiment, except that the wall clock 90 includes the imaging unit 93, and the wall clock 90 is provided with a wireless communication module that conforms to the same BLE standard as the second communication unit 42 (FIG. 3). Further, a time correction program is stored in a storage unit (not illustrated).

Time Correction Method

The time correction method in the time correction system 110 is the same as the time correction method of the first embodiment. First, the operation of the smartphone 10 is the same as in the flowchart illustrated in FIG. 4, and when the smartphone 10 starts the advertising, the smartphone 10 wirelessly transmits the advertising signal 60 to the broadcast in accordance with the set interval.

The operation of the smart watch 70 is the same as in the flowchart of the watch 30 illustrated in FIG. 4. Specifically, when the user long presses the operation button 71b for two seconds or longer, the time display mode switches to the time reception mode. The subsequent processing flow is the same as in the flowchart illustrated in FIG. 4, and when the smart watch 70 starts the scan and receives the advertising signal 60, the smart watch 70 corrects its own time.

Further, the multi-functional watch 80 and the wall clock 90 also perform the operation to switch to the time reception mode. In the multi-functional watch 80, the operation button 88b is long pressed for two seconds or longer. In the wall clock 90, the operation button 92 is pressed. In this way, the multi-functional watch 80 and the wall clock 90 also enter the time reception mode and, when the multi-functional watch 80 or the wall clock 90 starts the scan and receives the advertising signal 60, the multi-functional watch 80 or the wall clock 90 corrects its own time.

Note that when activating the wireless reception mode of the three timepieces including the smart watch 70, since the long pressing of the operation buttons is required, it is assumed that a time of 10 seconds or more is required until the wireless reception mode activated in all the timepieces. However, since the smartphone 10 on the transmission side performs the advertising for three minutes, as described above, it is sufficient that the wireless reception mode be activated during that time period. As long as the wireless reception mode is activated, the time required for the time correction is approximately one second.

Further, in the above description, the wireless transmission mode of the smartphone 10 is activated first. However, with respect to an activation order of the wireless transmission mode/wireless reception mode, either of the modes may be activated first, as long as a few seconds can be secured during which the operation of both modes overlaps. For example, the wireless reception modes of the smart watch 70, the multi-functional watch 80, and the wall clock 90 may be activated first.

As described above, according to the present embodiment, in addition to the advantages of the first embodiment, the following advantages can be obtained.

The time correction using the BLE standard broadcast communication can also be performed between the smartphone 10 and the smart watch 70, the multi-functional watch 80, and the wall clock 90 as the electronic timepieces. In other words, the time correction can be easily performed between the one device and the plurality of devices. Furthermore, even in the case of the one device and the plurality of devices, the power consumption when wirelessly transmitting the advertising signal 60 to the broadcast is the same as in the case of the one-to-one time correction.

Thus, the time correction method and the time correction system can be provided in which power consumption is small and the time correction of a plurality of timepieces can be performed simultaneously.

### Third Embodiment

Time Correction Aspect in which Transmission Mode and Reception Mode are Reversed

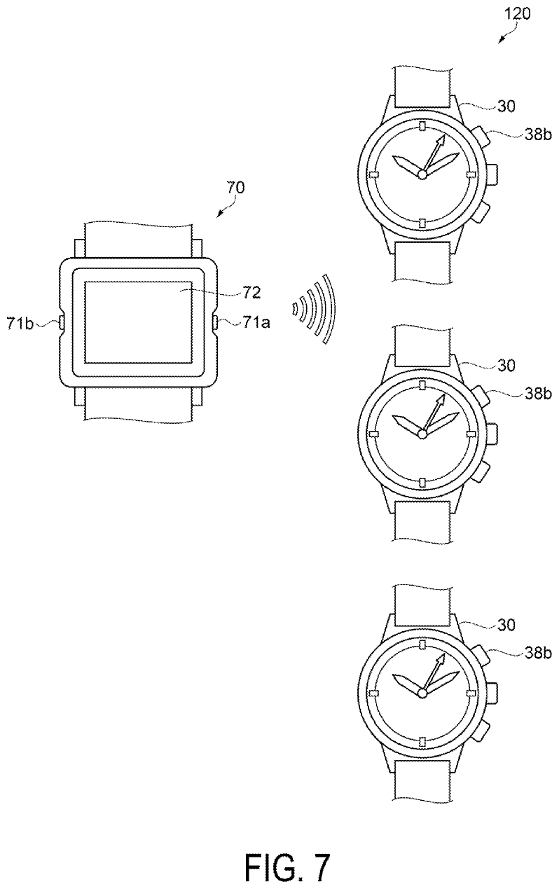

FIG. 7 is a schematic configuration diagram of a time correction system of the present embodiment, and corresponds to FIG. 1 and FIG. 6. Here, a time correction method in a time correction system 120 of the present embodiment will be described.

In the first embodiment and the second embodiment, the smartphone 10 is the broadcaster on the transmission side, but the configuration is not limited thereto, and the reception side may perform the role of the transmission side. Note that a description repeating that of the above embodiments will be omitted.

As illustrated in FIG. 7, the time correction system 120 is configured by the smart watch 70 and three of the watches 30.

The smartwatch 70 is the same as the smartwatch 70 according to the second embodiment, but takes on the role of the broadcaster on the transmission side. As described above, the time correction program is installed in the smart watch 70. In the present embodiment, the smart watch 70 is used as the broadcaster by using the touch panel of the display unit 72 to activate the time correction program and selecting a “start transmission” button from the operation screen.

The operation of the time correction program after activation is the same as that in the flowchart of the smartphone 10 illustrated in FIG. 4, and, by touching a “start advertising” button on the operation screen of the program, the smart watch 70 enters into the wireless transmission mode, and starts the advertising. When the advertising is started, the advertising signal 60 is wirelessly transmitted to the broadcast in accordance with the set interval.

The operation of the watch 30 is the same as the flowchart of the watch 30 illustrated in FIG. 4. Specifically, when the operation button 38b is long pressed for two seconds or longer, the time display mode switches to the time reception mode. When the watch 30 enters the time reception mode, starts the scan, and receives the advertising signal 60, the watch 30 corrects its own time.

As described above, according to the present embodiment, the following advantages can be achieved in addition to the advantages of the above-described embodiments.

While the smart watch 70 is the receiving side in the second embodiment, in the present embodiment, the smart watch 70 takes on the role of the transmission side. In other words, if it is the electronic apparatus or the electronic timepiece in which the wireless communication module conforming to the BLE standard and the time correction program are installed, either can take on the role of the broadcaster or the observer.

Thus, the time correction method and the time correction system can be provided that are easy to use and can easily correct the time with low power consumption.

### First Modified Example

A first modified example will be described with reference to FIG. 7.

In the above-described embodiments, in both the broadcaster or the observer, the starting of the wireless transmission/wireless reception is triggered by the operation by the user, but the configuration is not limited thereto.

For example, the time correction program of both the broadcaster and the observer may be executed using a predetermined time as the trigger. Specifically, 6 am is set in the time correction program as a regular correction time, and when the time is 6 am, in the smart watch 70, the time correction program is activated and the smart watch 70 starts the advertising as the broadcaster. In other words, the smart watch 70 automatically switches to the wireless transmission mode at the regular correction time.

Similarly, in the three watches 30, the time correction program is activated at 6 am and the watch 30 starts the scan as the observer. Then, when the watch 30 receives the advertising signal 60, the smart watch corrects its own time. In other words, the watch 30 automatically switches to the wireless reception mode at the regular correction time.

Further, the regular correction time is not limited to 6 am, nor limited to being every day, and the time and an interval may be set as appropriate, such as noon on the first day of each month, for example.

Further, the starting of the wireless transmission/wireless reception may also be triggered by a sensor. For example, detection of motion by a motion sensor of the watch 30 may be used as the trigger. Specifically, detection data from the motion sensor when the watch 30 is tapped twice continuously with a fingertip is set in advance as the trigger to start the wireless reception. In this way, it is possible to easily switch to the wireless reception mode by lightly tapping the watch 30, without long pressing the operation button. Alternatively, the trigger for starting the wireless reception may be set for a case in which the state of no detection of motion by the motion sensor continues for one week or more. In this case, it is assumed that the watch 30 has been left unused for one week or more, and thus the time correction is performed at this timing. Alternatively, the timing of the time correction may be set to a timing at which the motion is detected after there has no motion for one week or more.

Alternatively, a solar panel of the dial of the watch 30 may be used as an optical sensor, and detection data of the sensor may be used as the trigger. Since the solar panel generates power when it is irradiated with light, it can be used as a light sensor by sensing output power. For example, the timing for the time correction may be set to when a predetermined or greater illuminance is obtained after a dark state has continued for a predetermined time period. In this case, the morning is assumed. Alternatively, conversely, the timing for the time correction may be set to a time it becomes dark after a bright state has continued for a certain period of time.

Alternatively, when the device is provided with a camera, the wireless transmission/wireless reception may be started using image recognition. For example, since the wall clock 90 illustrated in FIG. 6 includes the imaging unit 93, when a predetermined image pattern is detected by image recognition of captured image data, this may be used as the switching trigger. The predetermined image pattern may be a characteristic image pattern such as an image of an open-palmed hand, or an image of a face of an owner, or the like. In this way, by raising the open-palmed hand toward the wall clock 90, the wireless reception mode can be activated.

Alternatively, when the device is provided with a microphone, the wireless transmission/wireless reception may be started using voice recognition. For example, the smartphone 10 in FIG. 1 is provided with a microphone in the audio processing unit 16 (FIG. 2), and thus, when predetermined audio data is detected by voice recognition, this is used as the switching trigger. The sound of clapping hands, a phrase such as “transmit time” or “receive time”, a melody, or the like may be set as the predetermined audio data. In this way, by saying “transmit time” toward the smartphone 10, the wireless transmission mode can be activated.

### Second Modified Example

A second modified example will be described with reference to FIG. 6.

In the embodiments described above, the smartphone 10 is exemplified as the electronic apparatus, and the multi-functional watch 80, the wall clock 90, and the watch 30 (FIG. 1) are exemplified as the electronic timepiece. However, the present disclosure is not limited thereto, and can be applied as long as it is applied to a device that includes a clocking unit and a wireless communication unit conforming to the BLE standard, and that is a device in which the time correction program is installed. For example, the present disclosure can be applied to an information terminal device, such as a tablet terminal device, a personal digital assistant (PDA), a wearable terminal device, an electronic paper terminal device, a laptop personal computer or the like, or to a household appliance, such as a digital timepiece, a clock, a flat panel television, an electric refrigerator, an electric washing machine or the like, or to public equipment such as traffic lights, and the like.

Although the above embodiments have been described using the wireless communication conforming to the BLE standard, the present disclosure is not limited thereto, and it is sufficient that it be a short-range wireless communication technology. The present disclosure may be applied to the ANT (registered trademark) wireless standard or a proprietary wireless communication technology, for example.

Contents derived from the embodiments will be described below.

A time correction method according to the present application is a time correction method performed using wireless communication between an electronic apparatus that includes a first wireless communication unit, and an electronic timepiece that includes a second wireless communication unit, the method including starting wireless reception by the electronic timepiece, generating, by the electronic apparatus, an advertising signal including time data held by the electronic apparatus, and starting transmission, by the electronic apparatus, of the advertising signal, and receiving, by the electronic timepiece, the advertising signal. The electronic timepiece updates time data held by the electronic timepiece based on the time data included in the received advertising signal.

According to this configuration, the electronic timepiece can acquire the time data without performing pairing between the electronic apparatus and the electronic timepiece. In this way, an operation relating to a pairing connection and a connection operation can be omitted, and thus the power consumption can be reduced and the time period up to the connection can be shortened.

Thus, the time correction method can be provided in which the power consumption is low and the time correction can be easily performed.

The first wireless communication unit and the second wireless communication unit may be wireless communication modules conforming to the BLE standard, and the wireless communication may be broadcast communication using the BLE standard.

According to this configuration, by using the broadcast communication according to the short-range wireless standard with low power consumption, it is possible to provide the time correction method in which the power consumption is low and the time correction can be easily performed.

The time data may include a date and a time.

According to this configuration, the date and the time can be corrected.

When the electronic apparatus starts transmission of the advertising signal, the electronic apparatus may repeatedly transmit the advertising signal at a predetermined interval until a predetermined time period elapses, and the electronic timepiece may end the wireless reception when reception of the advertising signal is successful.

According to this configuration, the power consumption can be further reduced since the wireless reception mode need not be continued.

The predetermined interval may be less than one second.

According to this configuration, it is possible to perform the time correction at every exact second without waiting for the next exact second.

The starting the wireless reception by the electronic timepiece may be performed when a time in the electronic timepiece is a predetermined regular correction time, and the start of the transmission of the advertising signal by the electronic apparatus may be performed when a time in the electronic apparatus is the regular correction time.

According to this configuration, since the time can be regularly corrected at the regular correction time, efficiency is achieved. Further, the time of the timepiece can always be maintained to be accurate.

The electronic timepiece may be provided in a plurality thereof.

According to this configuration, the time correction can be simultaneously performed for the plurality of electronic timepieces.

A time correction system according to the present application is a time correction including an electronic apparatus that includes a first wireless communication unit and an electronic timepiece that includes a second wireless communication unit. The time correction system includes standing by in a reception mode, by the electronic timepiece, when the second wireless communication unit receives an operation to enter the reception mode, and generating, by the electronic apparatus, an advertising signal including time data of the electronic apparatus, when the first wireless communication unit receives an operation to enter a transmission mode, and then starting advertising, by the electronic apparatus. When the electronic timepiece receives the advertising signal, the electronic timepiece updates time data of the electronic timepiece based on the time data included in the received advertising signal.

According to this time correction system, the electronic timepiece can obtain the time data without performing pairing between the electronic apparatus and the electronic timepiece. In this way, an operation relating to a pairing connection and a connection operation can be omitted, and thus the power consumption can be reduced and the time period up to the connection can be shortened.

Thus, the time correction system can be provided in which the power consumption is low and the time correction can be easily performed.

What is claimed is:

1. A time correction method performed using wireless communication between an electronic apparatus that includes a first wireless communication unit, and an electronic timepiece that includes a second wireless communication unit, the method comprising:
starting wireless reception by the electronic timepiece;
generating, by the electronic apparatus, an advertising signal including time data held by the electronic apparatus, and starting transmission, by the electronic apparatus, of the advertising signal; and
receiving, by the electronic timepiece, the advertising signal, wherein
the electronic timepiece updates time data held by the electronic timepiece based on the time data included in the received advertising signal.

2. The time correction method according to claim 1, wherein
the first wireless communication unit and the second wireless communication unit are wireless communication modules conforming to BLE standard, and
the wireless communication is broadcast communication using the BLE standard.

3. The time correction method according to claim 1, wherein
the time data includes a date and a time.

4. The time correction method according to claim 1, wherein
when the electronic apparatus starts transmission of the advertising signal, the electronic apparatus repeatedly transmits the advertising signal at a predetermined interval until a predetermined time period elapses, and
the electronic timepiece ends the wireless reception when reception of the advertising signal is successful.

5. The time correction method according to claim 1, wherein
the predetermined interval is less than one second.

6. The time correction method according to claim 1, wherein
the start of the wireless reception by the electronic timepiece is performed when a time in the electronic timepiece is a predetermined regular correction time, and
the start of the transmission of the advertising signal by the electronic apparatus is performed when a time in the electronic apparatus is the regular correction time.

7. The time correction method according to claim 1, wherein
a plurality of the electronic timepieces are provided.

8. A time correction system including an electronic apparatus comprising:
a first wireless communication unit; and
an electronic timepiece that includes a second wireless communication unit wherein
the electronic timepiece stands by in a reception mode, when the electronic timepiece receives an operation to enter the reception mode by the second wireless communication unit; and
the electronic apparatus generates an advertising signal including time data of the electronic apparatus, when the electronic apparatus receives an operation to enter a transmission mode by the first wireless communication unit, and then starts advertising, and
when the electronic timepiece receives the advertising signal, the electronic timepiece updates time data of the electronic timepiece based on the time data included in the received advertising signal.

9. The time correction system according to claim 8, wherein
the first wireless communication unit and the second wireless communication unit are wireless communication modules conforming to BLE standard; and
the wireless communication is broadcast communication using the BLE standard.

10. The time correction system according to claim 8, wherein
the time data includes a date and a time.

11. The time correction system according to claim 8, wherein
when the electronic apparatus starts transmission of the advertising signal, the electronic apparatus repeatedly transmits the advertising signal at a predetermined interval until a predetermined time period elapses, and
the electronic timepiece ends the wireless reception when the reception of the advertising signal is successful.

12. The time correction system according to claim 8, wherein
the predetermined interval is less than one second.

13. The time correction system according to claim 8, wherein
start of the wireless reception by the electronic timepiece is performed when a time in the electronic timepiece is a predetermined regular correction time, and
start of the transmission of the advertising signal by the electronic apparatus is performed when a time in the electronic apparatus is the regular correction time.

14. The time correction system according to claim 8, wherein
a plurality of the electronic timepieces are provided.
